(19) United States
(12) Patent Application Publication
(10) Pub. No.: US 2017/0148083 A1
(43) Pub. Date: May 25, 2017

(54) RECOMMENDING OF AN ITEM TO A USER

(71) Applicant: Hewlett Packard Enterprise Development LP, Houston, TX (US)

(72) Inventor: Xiaofeng Yu, Chaoyang District Beijing (CN)

(73) Assignee: Hewlett Packard Enterprise Development LP, Houston, TX (US)

(21) Appl. No.: 15/310,126

(22) PCT Filed: Jun. 12, 2014
(86) PCT No.: PCT/CN2014/079747

§ 371 Date: Nov. 10, 2016

(51) Int. Cl. G06Q 30/06; G06Q 50/00

(52) U.S. Cl. CPC G06Q 30/0631; G06Q 50/01

(57) ABSTRACT

The present disclose provides a method of recommending at least one item to a user, the method comprising: receiving the user's feedback on an item; predicting a user vector and an item vector related to the user in an online mode based on the received feedback; and recommending to the user an acceptable item based on the user vector and item vector.

### BACKGROUND

As the exponential growth of information generated on the World Wide Web, recommender systems have emerged as one of the hot research topics recently. Recommender systems form a specific type of information filtering technique that attempts to suggest information items (blogs, news, music, travel plans, web pages, images, tags, etc.) that are likely to interest the users. Recommender systems have been studied and developed both in academia and in industry. One of the most commonly-used and successfully-deployed recommendation approaches is collaborative filtering. Two types of such methods are widely studied. They are neighborhood-based approaches and model-based approaches. Neighborhood-based methods mainly focus on finding the similar users or items for recommendations. Model-based approaches use the observed user-item ratings to train a compact model that explains the given data, so that ratings could be predicted via the model instead of directly manipulating the original rating database as the neighborhood-based approaches do. Users however generally desire a fast recommendation response to their feedback. Also, users also hope that the recommended information or item is very close to what they desire, and thus a higher quality of recommendation is desirable.

### BRIEF DESCRIPTION OF THE DRAWINGS

The disclosure is described in detail in the following description in conjunction with the drawings. Features of the present disclosure are illustrated by way of non-limiting examples, in which:

FIG. 1 is a diagram of an example recommender system for recommending interesting items to users;

FIG. 2 is a flowchart of an example method for online recommendation of interesting items to users in real time;

FIG. 3 is a diagram showing a model of the probabilistic matrix factorization (PMF) recommendation algorithm;

FIG. 4 is a flowchart of an example method for online recommendation of interesting items to users with social and/or location Information;

FIG. 5 is a diagram of a social trust or friend network with weights;

FIG. 6 is a diagram of a model for a trust-based recommender system using a collective matrix factorization algorithm;

FIG. 7 is a diagram of a model for trust-based recommender system using a social trust ensemble algorithm; and

FIG. 8 is a diagram of a computer system for implementing examples of the disclosure.

Throughout the drawings, identical reference numbers designate similar, but not necessarily identical, elements.

### DETAILED DESCRIPTION

In the following detailed description of examples of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In general, examples of the disclosure provide a system and method for recommending interesting items to users.

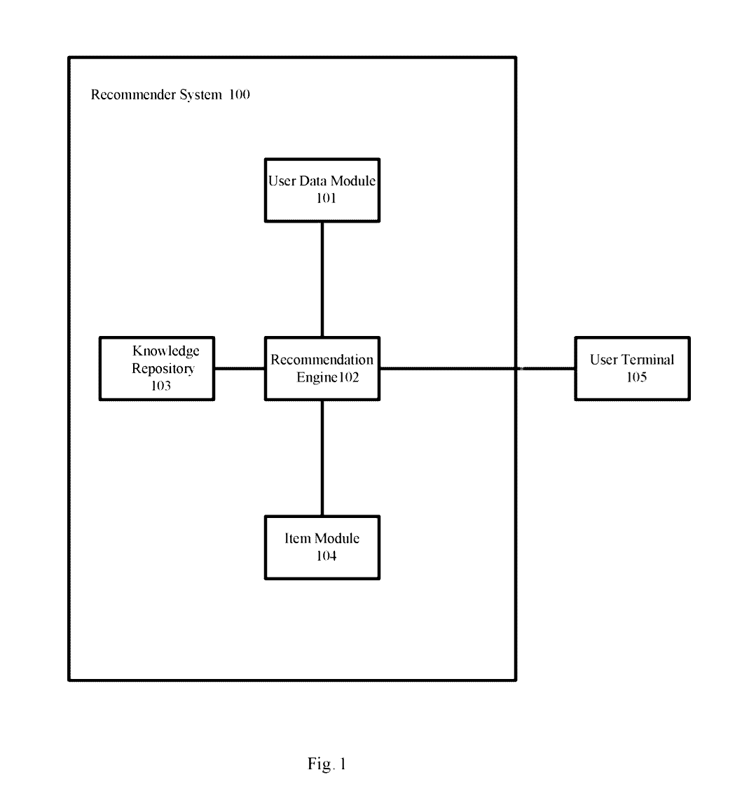

FIG. 1 shows a diagram of an example recommender system 100 for recommending interesting items to users. The recommender system 100 may include a user data module 101, a recommendation engine 102, a knowledge repository 103 and an item module 104.

The user data module 101 stores the user information such as user's age, gender, hobbies, interests, favorite sports, favorite fictions, songs and users' ratings on items. The user's information is used as the reference basis for recommending those items that possibly interest the user. The user's information is received by the recommender system from one or more terminals 105 used or operated by the user.

The terminals 105 may be any type of web enabled devices such as a server, a computer, a tablet, a smart phone or the like. In an example, the user may connect the terminals 105 to a website of the recommender system 100 via a network such as the Internet in either a cable or wireless way so as to access it to obtain recommendations on items or give their ratings or feedbacks on the items they are viewing or purchasing or intending to purchase.

In another example, the recommender system 100 may be equipped with its client applications which may have been developed for various types of the terminals 105. The users of the terminals 105 can download and install the client applications into the terminals 105 to obtain the recommendations on items. In an example, the client applications can be embedded into any other applications which may use a recommendation service as provided by the recommender system to recommend items to the users.

The recommendation engine 102 receives the user's information or user's feedback as above described from the terminals 105 and then generates a user matrix. The user matrix is a matrix which consists of several user vectors. For each user, there is a I-dimensional latent feature vector which is called a user vector. The recommendation engine 102 predicts a rating value for any of the items that the user may be interested in on the basis of the user's information or feedback or other users' rating values for the same item.

In another example, the recommendation engine 102 may merge the users' social information such as his/her friends' information about the same item or similar items, his/her relatives' information, his/her classmates' information with a user-item rating matrix to generate a recommended item to the user of the terminal 105. The user-item rating matrix consists of several ratings of the users on the respective items.

In yet another example, the recommendation engine 102 may merge the users' location information with the user-item rating matrix. The location information may involve context information, location, time, weather, and user request from the mobile device. The location information can be used to recommend a better preferred item, for example including a service, close to a geographical location where the user stays then.

The knowledge repository 103 stores any one of the user matrix, user-item rating matrix and item matrix. All the matrices could be stored in any other storage either internal or external to the recommender system. The user-item rating matrix consists of several ratings of the users on the respective items. The item matrix is a matrix which consists of several item vectors. For each item, there is a vector denoting a latent feature vector of this item which is called the item vector. The user-item rating matrix has a corresponding short term as a user-item matrix herein and they can be exchanged with each other herein. The stored user matrix, user-item rating matrix and item matrix in the knowledge repository 103 are used to further predict the rating values as the predicted results by the recommendation engine 102. The repository 103 also stores the predicted results from the recommendation engine 102.

The item module 104 basically stores all the attributes of the items to be recommended to the users, for example, names of the items, classifications of the items, such as music, song, fiction, book, clothes, sports gear, video, audio, learning material or the like, ages of the items, such as the times of the items being created, languages of the items, such as English, Chinese, French, etc.

In an example, the recommendation engine 102 generates an initial user-item matrix based on historical data, such as server access log files, for example by analyzing the historical data to find the user's information and/or feedback that the user has ever offered and/or information of the items to be recommended, and then stores the initial user-item matrix into the repository 103. The historical data records the user's old information and the user's old feedbacks on the items. The user's past information or feedbacks would or would not be updated by the user during their browsing of the websites showing the items or providing the user with an interface to edit their information or modify their feedback.

In another example, the recommendation engine 102 generates the initial user-item matrix based on the received user's information from the terminals 105 of the user.

In an example, the recommendation engine 102 updates the user vectors and item vectors (i.e. both user and item vectors) in the repository 103 immediately in response to receipt of the user's feedback on the items so that the user is given an instant online recommendation. It is desirable to online update the related user and item vectors of the repository corresponding to the new coming data from the user.

In another example, the recommender system 100 can be implemented by one or more servers, which can be connected with each other over a network. All the modules in the recommender system can be included in the same server or computer or can be distributed in different servers. For example, the recommendation engine 102 is located in a server, while the user data module 101, the repository 103 and the item module 104 are located in one server together or different servers respectively. The different configurations of all the components of the recommender system 100 can vary depending on the different requirements.

In yet another example, all the components of the recommender system 100 can be integrated into one component such as the recommendation engine 102.

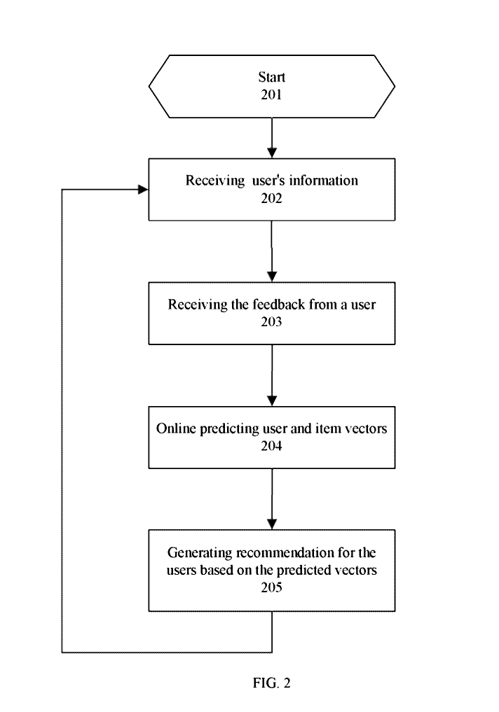

FIG. 2 is a flowchart of an example method of online recommending the interesting items to the users. The method can be implemented in hardware, software or firmware or any combination thereof.

The method starts at block 201. In an example, the method starts for example after the recommender system implementing the method boots up. The system recommends to the users the items which for example are shown on the website page or application page or search engine page. The items may be shown anywhere the user can view (e.g., on different sections of a display).

In block 202, the user signs in on the website of the recommender system or any website using the recommendation service provided by the recommender system. The user enters his/her personal information such as his/her name, nickname, an accessible email address, account name, password, his/her favorite preferences such as his/her favorite songs, singers, film types, actors or actresses, newspapers, books, clothes brands or the like. As a result, the user's information is received. If the user is not willing to provide such kind of information, he/she will be recommended a possibly interesting item based on his/her feedback to the item or his/her rating to this item.

In block 203, the immediate feedback from the user on an item, such as his/her viewing times of the items or his/her ratings on the items is received and stored in a storage means, for example, in the user data module. The feedback may include but not limited to, for example, user's comments, user's like or dislike, user's following or unfollowing of the items, whether the user has recommended the items to his/her friends or not, or any other representation reflecting the user's attitude or preference to the items.

In block 204, upon receipt of the user's feedback on the item, the method starts to update or predict only the user vector and the item vector for the user who just provided the feedback. It is unnecessary to wait the feedback from all the users. For example, the recommendation engine 102 stores the user's feedback into the user data module and adds a new row reflecting the user's feedback or updating of preferences to the user matrix. The recommendation engine 102 or similar device processes the received feedback from the user, that is, new data from the user. The update is done in an online mode in a real time. The online mode herein refers to an online recommendation manner, under which the user and item vectors are updated immediately in response to receipt of the user's feedback on the items. With the online recommendation manner, the user can be given an instant online recommendation. With this example, the user can obtain the recommended items soon after his/her feedback is done. The online updating or predicting algorithm used by the recommendation engine as a recommendation algorithm will be described in detail as follows.

Next, the recommendation algorithm will be introduced. A proposed example of the recommendation algorithm as used by the recommender system at block 204 is a factorization-based collaborative filtering method. Here, a Probabilistic Matrix Factorization (PMF) used in the factorization-based collaborative filtering method may be taken as a classical factorization-based model to show how the recommender system or method predicts the user vector and the item vector based on the new coming data. It will be appreciated that other recommendation algorithms can also be applied herein within the scope of the spirit and principle of the disclosure.

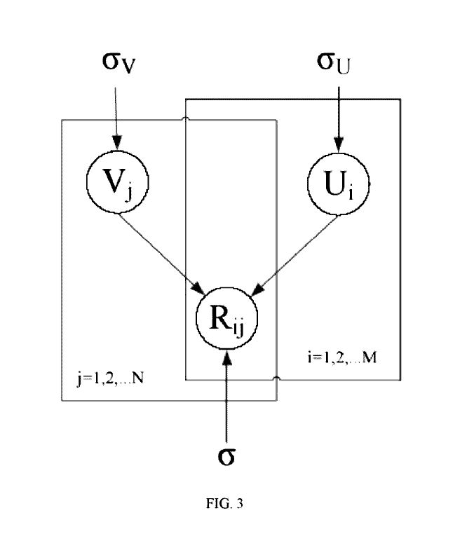

By referring to FIG. 3 showing the probabilistic graph of PMF, it is assumed that there are M users and N items. For each user and item, there is a l-dimensional latent feature vector.

TABLE 1
(User Matrix)
$U = [ \begin{matrix}1.55 & 1.22 & 0.37 & 0.81 & 0.62 & - 0.01 \\ 0.36 & 0.91 & 1.21 & 0.39 & 1.10 & 0.25 \\ 0.59 & 0.20 & 0.14 & 0.83 & 0.27 & 1.51 \\ 0.39 & 1.33 & - 0.43 & 0.70 & - 0.90 & 0.68 \\ 1.05 & 0.11 & 0.17 & 1.18 & 1.81 & 0.40\end{matrix} ]$

Table 1 shows an example user matrix which is denoted as UεR^{l}*^{M} wherein there are a total of 6 users as denoted by the respective columns and each column represents the user vector.

The dimension l of the user matrix U is 5. Uᵢ is the column vector and denotes the latent feature vector of user uᵢ, wherein i=1, 2, 3 . . . M. All the vectors for the users are generated based on the received information from the users. The information may be the new data from the user or has been stored in the user data module.

TABLE 2
(Item Matrix)
$V = [ \begin{matrix}1.00 & - 0.05 & - 0.24 & 0.26 & 1.28 & 0.54 & - 0.31 & 0.52 \\ 0.19 & - 0.86 & - 0.72 & 0.05 & 0.68 & 0.02 & - 0.61 & 0.70 \\ 0.49 & 0.09 & - 0.05 & - 0.62 & 0.12 & 0.08 & 0.02 & 1.60 \\ - 0.40 & 0.70 & 0.27 & - 0.27 & 0.99 & 0.44 & 0.39 & 0.74 \\ 1.49 & - 1.00 & 0.06 & 0.05 & 0.23 & 0.01 & - 0.36 & 0.80\end{matrix} ]$

Table 2 shows an example of the item matrix consisting of the item vectors for the items to be recommended to the users which is denoted as VεR^{l}*^{N}, wherein there are a total of 8 items as denoted by the respective columns. The dimension l of the feature vector V is 5. Vj is the column vector, i.e. the item vector, and denotes the latent feature vector of item vj, wherein j=1, 2, 3 . . . N. All the item vectors are generated based on the information of the items. The item information could be newly received or has been stored in the item module. For example, the item information could include types of the items, publication times of the items, friendliness of the items, prices of the items, production places of the items, languages of the items, popularity of the items, etc.

TABLE 3
(Initial user-item rating matrix)

| | i₁ | i₂ | i₃ | i₄ | i₅ | i₆ | i₇ | i₈ |
|---|---|---|---|---|---|---|---|---|
| u₁ | 5 | 2 | | 3 | | 4 | | |
| u₂ | 4 | 3 | | | 5 | | | |
| u₃ | 4 | | 2 | | | | 2 | 4 |
| u₄ | | | | | | | | |
| u₅ | 5 | 1 | 2 | | 4 | 3 | | |
| u₆ | 4 | 3 | | 2 | 4 | | 3 | 5 |

Table 3 denotes an initial user-item rating matrix, for example. In an example, the initial ratings of the users on the respective items are obtained from the feedback as received from the user at block 203. In another example, the initial ratings may be obtained based on the historical data, for example, by analyzing the historical data such as the access log. For example, the unit (u₁, i₁) in Table 3 indicates that the user 1 gave a rating of 5 on the item 1. There are some empty units in Table 1 for which the users did not give any ratings.

TABLE 4
Predicted user-item rating matrix)

| | i₁ | i₂ | i₃ | i₄ | i₅ | i₆ | i₇ | i₈ |
|---|---|---|---|---|---|---|---|---|
| u₁ | 5 | 2 | 2.5 | 3 | 4.8 | 4 | 2.2 | 4.8 |
| u₂ | 4 | 3 | 2.4 | 2.9 | 5 | 4.1 | 2.6 | 4.7 |
| u₃ | 4 | 1.7 | 2 | 3.2 | 3.9 | 3.0 | 2 | 4 |
| u₄ | 4.8 | 2.1 | 2.7 | 2.6 | 4.7 | 3.8 | 2.4 | 4.9 |
| u₅ | 5 | 1 | 2 | 3.4 | 4 | 3 | 1.5 | 4.6 |
| u₆ | 4 | 3 | 2.9 | 2 | 4 | 3.4 | 3 | 5 |

Table 4 shows an example of predicted user-item rating matrix by the recommender engine using the algorithm. In Table 4, the empty units are added the predicted rating values. Next, predicting of the missing rating values is described.

Let Rᵢⱼ denote the rating of item j given by user i (for example, as shown in Table 3 and Table 4) wherein the rating is represented by the rating value; and a proposed recommender system may use an integer rating value from 1 to K wherein K may be equal to 5 in Table 3 and Table 4. Other range for the rating value is optional depending on the specific requirements. The rating value represents the users' judgments on items. The ratings 1, . . . , K can be mapped to the interval [0, 1] by means of normalization. In the graph of FIG. 3, the distribution of Rᵢⱼ is defined as

$${P ( R \vert U , V , {σ}^{2} ) = {\prod }_{i = 1}^{M} {\prod }_{j = 1}^{N} [ N ( {R}_{ij} \vert g ( {U}_{i}^{T} {V}_{j} ) , {σ}^{2} ) ]}^{{I}_{ij}} , \qquad ( 1 )$$

where N(x|u,σ²) is a Gaussian distribution with the mean u and variance σ⁻². g(x) is the logistic function g(x)=1/(1+exp(−x)) to convert Uᵢ^{T}Vⱼ to [0, 1] scale. Iᵢⱼ is an indicator to describe whether user i has rated item j or not. Next, the method predicts the missing rating values in the user-item rating matrix (for example in Table 3) using Uᵢ^{T}Vⱼ. Before the prediction, it may firstly be required to transfer the value of Uᵢ^{T}Vⱼ using some logistic function g(x). Therefore, all the rating missing values can be predicted using the matrices U and V. Note that even though user u4 did not rate any items in Table 3 with his/her whole row being blank, a proposed online prediction algorithm can be used to predict reasonable ratings for those missing units as shown in Table 4. The online prediction algorithm refers to an algorithm used by the recommender system to predict the rating value for the user in the online mode. Next, the online prediction algorithm will be introduced.

In order to predict the rating value, it may be required to use an objective function of PMF. The objective function generally refers to an equation to be optimized given certain constraints and with variables. The objective function of PMF is to find U, V by minimizing the summation of regression loss and regularization as

$$arg { min}_{U , V} \frac{1}{2} {\sum }_{i = 1}^{M} {\sum }_{j = 1}^{N} {{I}_{ij} ( {R}_{ij} - g ( {U}_{i}^{T} {V}_{j} ) )}^{2} + \frac{λ}{2} ( {‖ U ‖}_{F}^{2} + {‖ V ‖}_{F}^{2} ) . \qquad ( 2 )$$

Eq. (2) is used to minimize the summation of regression loss and regularization. Eq. (2) is a mathematical optimization method where λ is the regularization factor and can be changed depending on the specific requirements.

In order to predict the rating value for the user in the online mode, the prediction algorithm in Eq. (2) needs to be changed as follows. The proposed method of FIG. 2 optimizes the local objective function. The local objective function is either a loss function or its negative. The loss function is a function that maps an event (for example, the event is to predict the ratings in the user-item rating matrix) or values of one or more variables onto a real number intuitively representing some “cost” associated with the event. The proposed local objective function is just a kind of loss function. For example, in case that the new incoming data from the user is Rᵢⱼ, the local objective function for the online mode is

$$arg {min}_{{U}_{i} , {V}_{j}} 𝓁 = arg {min}_{{U}_{i} , {V}_{j}} \frac{1}{2} {( {R}_{ij} - g ( {U}_{i}^{T} {V}_{j} ) )}^{2} + \frac{λ}{2} ( {‖ {U}_{i} ‖}_{F}^{2} + {‖ {V}_{j} ‖}_{F}^{2} ) . \\ 𝓁 = \frac{1}{2} {( {R}_{ij} - g ( {U}_{i}^{T} {V}_{j} ) )}^{2} + \frac{λ}{2} ( {‖ {U}_{i} ‖}_{F}^{2} + {‖ {V}_{j} ‖}_{F}^{2} ) . \qquad ( 3 )$$

Here, l is the local objective function with quadratic regularization terms to be minimized. By comparing Eq. (3) with Eq. (2), it can be seen that the prediction algorithm by Eq. (3) does not handle all the users and items but only the user who just provided their feedback. This will further reduce the time spent on updating the user-item matrix while reducing the response time to the user's feedback. In Eq. (3), only two vectors (Ui and Vj) need to be tuned so that the calculation complexity is further reduced. Considering the above definition of the objective function of PMF as the online prediction algorithm, the feature vectors, i.e., Uᵢ and Vⱼ, can be updated as

$$\begin{matrix}{U}_{i} = {U}_{i} + r * \frac{\partial 𝓁}{\partial {U}_{i}} , & ( 4 ) \\ {V}_{j} = {V}_{j} + r * \frac{\partial 𝓁}{{\partial }_{j}} , & ( 5 )\end{matrix}$$

where r is an updating or predicting rate. In the example, only two vectors (Uᵢ and Vⱼ) are dynamically updated upon receipt of the user's feedback. Eqs. (4) and (5) may be obtained by different mathematical optimization methods, such as gradient descent, Newton iteration, etc. Through Eqs. (4) and (5), both Uᵢ and Vⱼ are iterated and updated to obtain the optimal.

The loss function used in the PMF as the local objective function is the root mean square function. The generic function of the local objective function by Eq. (3) is

$$arg {min}_{U , V} \frac{1}{2} loss ( U , V ) + \frac{λ}{2} ( {‖ U ‖}_{F}^{2} + {‖ V ‖}_{F}^{2} ) . \qquad ( 6 )$$

Please note that Eq. (6) is a generic version of Eq. (3) and Eq. (3) is the specific version of Eq. (6). In addition to Eq. (3), other objective functions can also be used to update only the two vectors for the user and item within the scope of the spirit and principle of the disclosure. A proposed similar local objective function could be expressed as

$$arg {min}_{{U}_{i} , {V}_{j}} \frac{1}{2} loss ( {U}_{i} , {V}_{j} ) + \frac{λ}{2} ( {‖ {U}_{i} ‖}_{F}^{2} + {‖ {V}_{j} ‖}_{F}^{2} ) . \qquad ( 7 )$$

For the local objective function in Eq. (7), the same Eqs. (4) and (5) can be also used to update the user vector Ui and the item vector Vj. Eqs. (4) and (5) are very general iteration equations in mathematical optimization method.

With continued reference to FIG. 2, after updating the two vectors, the method goes to block 205. In block 205, the interesting items could be recommended to the user based on the predicted user and item vectors. For example, the recommender system updates the user-item matrix based on the predicted user and item vectors and then recommends, based on the ranking of the rating values in the predicted user-item rating matrix, the acceptable items to the user who, for example, just now sent the feedback or rating values on similar items or have provided his/her information to the system.

Eq. (1) defines the distribution of the user-item rating matrix R. Note that in this equation R is related to the user matrix U and the item matrix V. After U and V are optimized (e.g., via Eq. (4) and Eq. (5)) to minimize the local objective function (e.g., via Eq. (3)), the user-item rating matrix R via Eq. (1) can be updated.

In another example, when the user is to be recommended the acceptable items, the user's preferences could be further considered. For example, before the interesting items are sent to the user, a determination could be made to check whether the interesting items are close to the preferences or not. Afterwards, the method returns to block 202 where the user's further feedback will be waited to be entered or the existing user could update or modify his/her information or a new user enters his/her information.

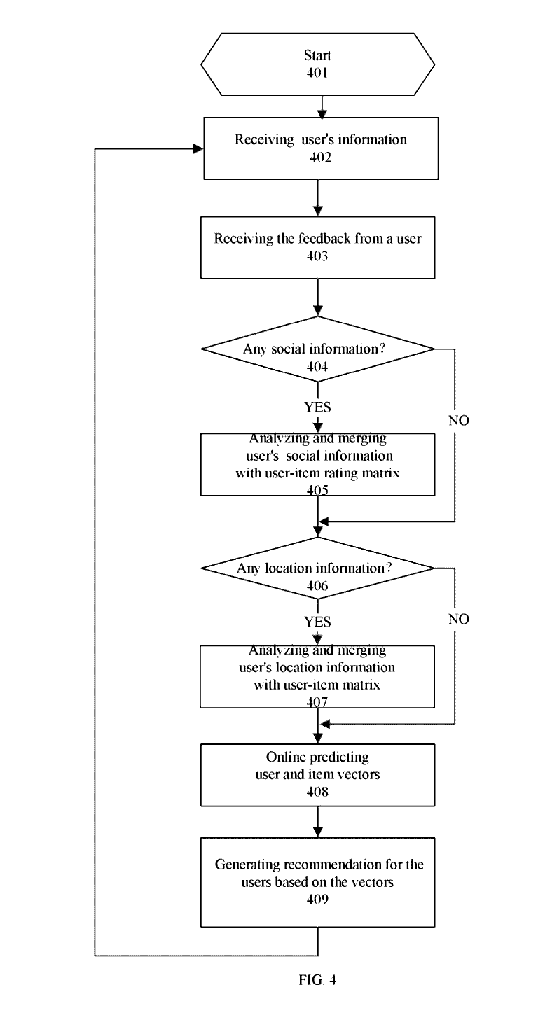

FIG. 4 is a flowchart of an example method of online recommendation of interesting items to the users with social and/or location information. The method considers the social relationships among users and information and services related to user's physical location. The social relationships of the users may involve the user's social information such as information related to his/her friends, his/her trusted group or people or his/her relatives, etc and can be considered in recommendation of interesting items to the users. The user's location information may involve context information, location, time, weather, and user request from the mobile device and can be used to infer the most preferred item to provide an appropriate service to the user.

In block 401, the method operates basically similar to the block 201. Besides, the user is requested to authorize the recommender system to access his/her contact list from which his/her friends or trusted people or group can be obtained or to access his/her information related to the location where he/she stays for example.

In block 402, the user signs in on the website of the recommender system or any website using the recommendation service provided by the recommender system. The user enters his/her personal information such as his/her name, nickname, an accessible email address, account name, password, his/her favorite preferences such as his/her favorite songs, singers, film types, actors or actresses, newspapers, books, clothes brands or the like. As a result, the user's information is received. If the user is not willing to provide such kind of information, he/she will be recommended a possibly interesting item based on his/her feedback to the item or his/her rating to this item.

In block 403, the method operates basically similar to the block 203 where the user's immediate feedback to the item is received.

In block 404, in order to recommend to the user a more accurate item, the method considers the user's social information such as his/her friend's or his/her relative's information because his/her social information would provide some helpful information as the recommendation basis. In block 404, it is determined that the user has any social information based on the user's own information as entered by the user when he/she signed in or as obtained from his/her other social account in a social media website, for example. If so, then the method goes to block 405.

In block 405, the user's social information will be analyzed to find his/her friends' or relatives' preferences and merged with the user-item rating matrix. The users for recommender system are not alone. They are in a social network. Trust or friend relations are issued by users on the Web. The block 405 combines the social information (as shown in Table 5 showing the social trust or friend network) with the user-item rating matrix as shown in Table 5 in order to improve recommendation quality.

TABLE 5
(User-item rating matrix)

| | i₁ | i₂ | i₃ | i₄ | i₅ | i₆ |
|---|---|---|---|---|---|---|
| u₁ | | 5 | 2 | | 3 | |
| u₂ | 4 | | | 3 | | 4 |
| u₃ | | | 2 | | | 2 |
| u₄ | 5 | | | 3 | | |
| u₅ | | 5 | 5 | | | 3 |

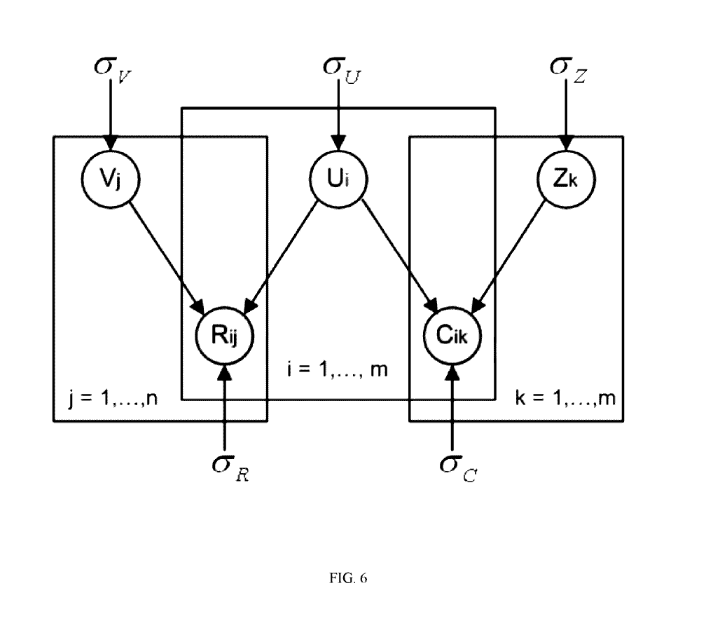

In an example, the user social network matrix and user-item rating matrix can be factorized at the same time by sharing the same user latent space, as shown in FIG. 6 showing the model for a trust-based recommender system using a collective matrix factorization algorithm.

The posterior probability for the model may be expressed below:

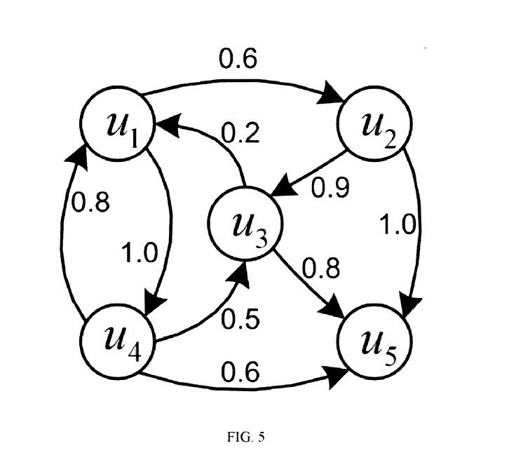

p(U,V,Z|C,R,σ_{C}²,σ_{R}²,σ_{U}²,σ_{V}²,σ_{Z}²)∝p(R|U,V,σ_{R}²)p(C|U,Z,σ_{C}²)p(U|σ_{U}²)p(V|σ_{V}²)p(Z|σ_{Z}²), (8)

where U, V, and C are the user matrix, item matrix and the social network matrix. An example social network graph is shown in FIG. 5. There are 5 users in total (nodes, from u1 to u5) with 9 relations (edges) between users in this graph, and each relation is associated with a weight wᵢⱼ in the range [0, 1] to specify how much the user uᵢ knows or trusts user uⱼ. As a result, C is a 5×5 social network matrix, and each weight wᵢⱼ in C (wᵢⱼ is in [0, 1]) denotes the weight associated with an edge from uᵢ to uⱼ.

TABLE 6
(Social network matrix)

| | u1 | u2 | u3 | u4 | u5 |
|---|---|---|---|---|---|
| u1 | | 0.6 | | 1.0 | |
| u2 | | | 0.9 | | 1.0 |
| u3 | 0.2 | | | | 0.8 |
| u4 | 0.8 | | 0.5 | | 0.6 |
| u5 | | | | | |

Table 6 shows the social network matrix reflecting the graph shown in FIG. 5.

In Eq. (8), Z is the latent factor feature matrix with column vector Zk representing factor-specific latent feature vector, wherein k=1, 2, 3 . . . m. The latent factor feature matrix, Z, is similar to the user matrix U in Table 1 and the item matrix V in Table 2.

An example of Z is as follows:

$$Z = \vert \begin{matrix}1.39 & 1.20 & 0.42 & 0.56 & 0.83 \\ 0.22 & - 0.15 & 0.77 & 1.25 & 1.07 \\ 1.11 & - 0.19 & 0.23 & 1.57 & 0.67 \\ 0.25 & - 0.59 & 0.44 & - 1.43 & 0.68 \\ 0.16 & 0.17 & 1.33 & 0.89 & 1.89\end{matrix} \vert$$

Each column vector represents factor-specific latent social feature vector for a user. According to Eq. (8), Z is related to the user matrix U and the social network matrix C.

Eq. (8) is equivalent to minimization of the following objective function:

$$\frac{1}{2} {\sum }_{i = 1}^{m} {\sum }_{j = 1}^{n} {{I}_{ij}^{R} ( {r}_{ij} - g ( {U}_{i}^{T} {V}_{j} ) )}^{2} + \frac{{λ}_{C}}{2} {\sum }_{i = 1}^{m} {\sum }_{k = 1}^{n} {{I}_{ik}^{C} ( {c}_{ik} - g ( {U}_{i}^{T} {Z}_{k} ) )}^{2} + \frac{{λ}_{U}}{2} {‖ U ‖}_{F}^{2} + \frac{{λ}_{V}}{2} {‖ V ‖}_{F}^{2} + \frac{{λ}_{Z}}{2} {‖ Z ‖}_{F}^{2} . \qquad ( 9 )$$

The users' social trust network is integrated into the recommender system by factorizing the social trust graph. The challenge of this model is that the real world recommendation processes are not reflected in the model.

This challenge not only causes lack of interpretability in the model, but also affects the recommendation qualities.

Hence, based on the observations of the real-world recommendation process, three assumptions can be made as follows:

Users have their own characteristics, and they have different tastes on different items, such as movies, books, music, articles, food, etc.

Users can be easily influenced by the friends they trust, and prefer their friends' recommendations.

One user's final decision is the balance between his/her own taste and his/her trusted friends' favors.

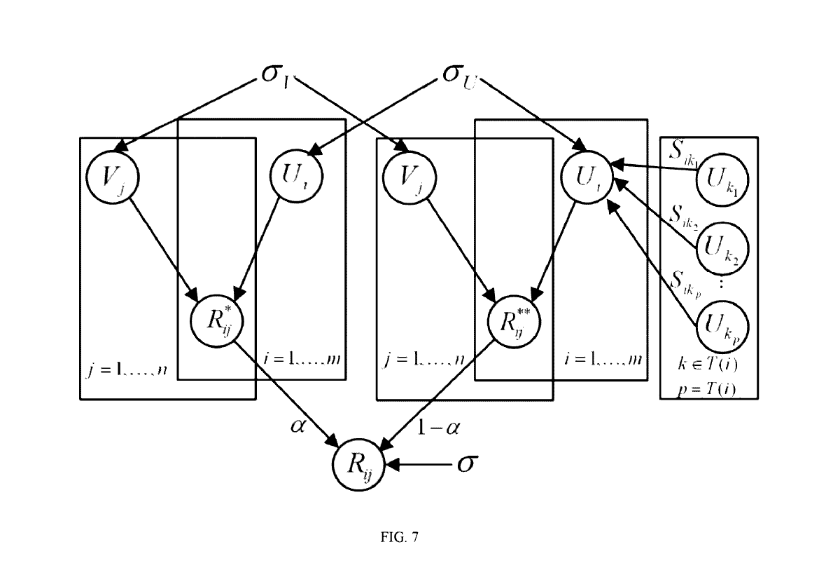

Based on these three motivations, the problem can be reformulated as the social trust ensemble problem and drawn the graphical model as in FIG. 7 showing the model for trust-based recommender system using a social trust ensemble.

This will result in minimizing the following objective function:

$$\frac{1}{2} {\sum }_{i = 1}^{m} {\sum }_{j = 1}^{n} {{I}_{ij}^{R} ( {R}_{ij} - g ( {αU}_{i}^{T} {V}_{j} + ( 1 - α ) {\sum }_{k ∈ T ( i )} {S}_{ik} {U}_{k}^{T} {V}_{j} ) )}^{2} + \frac{{λ}_{U}}{2} {‖ U ‖}_{F}^{2} + \frac{{λ}_{V}}{2} {‖ V ‖}_{F}^{2} . \qquad ( 10 )$$

The users' favors αUᵢ^{T}Vⱼ and the trusted friends' favors

$${\sum }_{k ∈ T ( i )} {S}_{ik} {U}_{k}^{T} {V}_{j}$$

are smoothed by the parameter α, (α is in [0, 1]) which naturally fuses appropriate amount of real world recommendation processes into the recommender systems. The parameter α controls how much users do trust themselves or their trusted friends. S is the social trust matrix. S is very similar to C, but in C, the relationships can be any social relations. In the social trust matrix S, only the trust relationships could be considered.

An example of social trust matrix S is as follows:

TABLE 8
(social trust matrix S)

| | | | | |
|---|---|---|---|---|
| u1 | u2 | u3 | u4 | u5 |

| | | | |
|---|---|---|---|
| u1 | 0.6 | | |
| u2 | | | |
| u3 | 0.2 | | |
| u4 | 0.8 | 0.5 | 0.6 |
| u5 | | | |

Note that this matrix is similar to Table 6. The difference is that only trust relationship can be considered in S. In S, each weight (e.g., 0.5) specifies how much a user trusts another user (e.g., his/her friend).

With continued reference to FIG. 4, if it is determined at block 404 that there is no social information for the user, then the method branches to block 406. In block 406, the method determines whether the user has any location information such as the country, the city, the shopping, the library, the cinema, the school, the street, the interesting places where the user is staying or traveling or visiting, the time, weather, or user request from the mobile device or other web enabled device. The location information may be any other type of location information. If so, then the method proceeds to block 407.

In block 407, the user's location information is analyzed and then merged with the user-item matrix as the recommendation references. As wireless communication advances, research on location-based services (LBS) using mobile devices has attracted interest, which provides information and services related to user's physical location. The example collects rich information such as context information, location, time, weather, and user request from the mobile device.

The above mentioned collective matrix factorization framework can be easily extended to merge the user-item rating matrix with the users' location information matrix. Similar factor analysis approach can be used by utilizing both users' rating information and location information at the same time in light of the facts that both users' rating information and users' location information can reflect their opinions about the Web content. Specifically, on the one hand, users' rating information can be connected with users' location information through the shared user latent feature space. On the other hand, received rating information on items can be connected with location information through the shared item latent feature space.

Let G=(ν,ε) be an undirected network graph, where the vertex set represents all the users in a social network, and the edge set represents the location information (distances, e.g., from 0 km to Tkm. The distances 0 km, . . . , Tkm can be mapped to the interval [0, 1].) between users. Let L={lᵢₖ} be the location network matrix of G. For a pair of vertices, let lᵢₖ in [0,1] denotes the location weight associated with them.

TABLE 7
(location network matrix)

| | u1 | u2 | u3 | u4 | u5 |
|---|---|---|---|---|---|
| u1 | 0 | 1 | | | |
| u2 | 1 | 0 | 0.5 | | |
| u3 | | 0.5 | 0 | 0.8 | |
| u4 | | | 0.8 | 0 | 0.7 |
| u5 | | | | 0.7 | 0 |

Table 7 shows an example location network matrix. The physical meaning of the location weight can be interpreted as how close the two users are. The lower the location weight is, the closer the two users are. Note that L is a symmetric matrix. Let Y be the latent location factor feature matrix, with column Yk representing location factor-specific latent feature vectors, the objective function to minimize is as follows:

$$\frac{1}{2} {\sum }_{i = 1}^{m} {\sum }_{j = 1}^{n} {{I}_{ij}^{R} ( {r}_{ij} - g ( {U}_{i}^{T} {V}_{j} ) )}^{2} + \frac{{λ}_{L}}{2} {\sum }_{i = 1}^{m} {\sum }_{k = 1}^{m} {{I}_{ik}^{L} ( {l}_{ik}^{*} - g ( {U}_{i}^{T} {Y}_{k} ) )}^{2} + \frac{{λ}_{U}}{2} {‖ U ‖}_{F}^{2} + \frac{{λ}_{V}}{2} {‖ V ‖}_{F}^{2} + \frac{{λ}_{Y}}{2} {‖ Y ‖}_{F}^{2} . \qquad ( 11 )$$

Besides the location information, there is also some other user implicit data or temporal data generated in on-line recommender systems, such as users' purchasing data, click data, etc.

Besides, if it is determined that there is no location information in block 406, then the method goes to block 408.

In block 408, the recommendation engine or similar device predicts the user vector and the item vector.

Firstly, the prediction of the user vector and item vector by considering the user's social information will be introduced below.

As described in the example, by incorporating social information, the main difference from the PMF model is that the loss function for the objective function is changed. Thus the same online recommendation framework (as shown in Eq. 7, Eq. 4 and Eq. 5) could be utilized to convert these batch social recommendation algorithms into online social recommendation algorithms.

A local minimum of the objective function I given by Eq. (10) can be found by performing gradient descent in Ui and Vj as follows:

$$\frac{\partial L}{\partial {U}_{i}} = α {\sum }_{j = 1}^{n} {I}_{ij}^{R} {g}^{′} ( {αU}_{i}^{T} {V}_{j} + ( 1 - α ) {\sum }_{k ∈ T ( i )} {S}_{ik} {U}_{k}^{T} {V}_{j} ) {V}_{j} \times ( g ( {αU}_{i}^{T} {V}_{j} + ( 1 - α ) {\sum }_{k ∈ T ( i )} {S}_{ik} {U}_{k}^{T} {V}_{j} ) - {R}_{ij} ) + ( 1 - α ) {\sum }_{p ∈ B ( i )} {\sum }_{j = 1}^{n} {I}_{pj}^{R} {g}^{′} ( α {U}_{p}^{T} {V}_{j} + ( 1 - α ) {\sum }_{k ∈ T ( p )} {S}_{pk} {U}_{k}^{T} {V}_{j} ) \times ( g ( α {U}_{p}^{T} {V}_{j} + ( 1 - α ) {\sum }_{k ∈ T ( p )} {S}_{pk} {U}_{k}^{T} {V}_{j} ) - {R}_{pj} ) {S}_{pi} {V}_{j} + {λ}_{U} {U}_{i} , \\ \frac{\partial L}{\partial {V}_{j}} = {\sum }_{i = 1}^{m} {I}_{ij}^{R} {g}^{′} ( α {U}_{i}^{T} {V}_{j} + ( 1 - α ) {\sum }_{k ∈ T ( i )} {S}_{ik} {U}_{k}^{T} {V}_{j} ) \times ( g ( α {U}_{i}^{T} {V}_{j} + ( 1 - α ) {\sum }_{k ∈ T ( i )} {S}_{ik} {U}_{k}^{T} {V}_{j} ) - {R}_{ij} ) \times ( α {U}_{i} + ( 1 - α ) {\sum }_{k ∈ T ( i )} {S}_{ik} {U}_{k}^{T} ) + {λ}_{V} {V}_{j} . \qquad ( 12 )$$

The updating equations are similar to Eqs. (4) and (5).

Using social trust relationships, the recommendation result (or the predicted user-item rating matrix) is also similar to the predicted user-item rating matrix as shown in Table 4, but because of considering the user's social information, the predicted result will become different. Actually, for all recommendation models in this disclosure, the recommendation results are similar to the predicted user-item rating matrix as shown in Table 4. In this disclosure, trust relationship and friend relationship are classified into the same class, but they may also be separately incorporated into the user-item matrix in the similar way as above explained.

Next, the prediction of the user vector and item vector by considering the user's location information will be introduced below.

The local minimum of the objective function I given by Eq. (11) can be found by performing gradient descent in Uᵢ, Vⱼ and Yₖ as

$$\frac{\partial L}{\partial {U}_{i}} = {\sum }_{j = 1}^{n} {I}_{ij}^{R} {g}^{′} ( {U}_{i}^{T} {V}_{j} ) ( g ( {U}_{i}^{T} {V}_{j} ) - {r}_{ij} ) {V}_{j} + {λ}_{L} {\sum }_{j = 1}^{m} {I}_{ik}^{L} {g}^{′} ( {U}_{i}^{T} {Y}_{k} ) ( g ( {U}_{i}^{T} {Y}_{k} ) - {l}_{ik}^{*} ) {Y}_{k} + {λ}_{U} {U}_{i} , \\ \frac{\partial L}{\partial {V}_{j}} = {\sum }_{i = 1}^{m} {I}_{ij}^{R} {g}^{′} ( {U}_{i}^{T} {V}_{j} ) ( g ( {U}_{i}^{T} {V}_{j} ) - {r}_{ij} ) {U}_{i} + {λ}_{V} {V}_{j} , \\ \frac{\partial L}{\partial {Y}_{k}} = {λ}_{L} {\sum }_{i = 1}^{m} {I}_{ik}^{L} {g}^{′} ( {U}_{i}^{T} {Y}_{k} ) ( g ( {U}_{i}^{T} {Y}_{k} ) - {l}_{ik}^{*} ) - {U}_{i} + {λ}_{Y} {Y}_{k} , \qquad ( 13 )$$

where g′(x) is the derivative of logistic function g′(x)=exp(x)/(1+exp(x)).

In another example, in order to reduce the model complexity, a proposed setting manner could be λ_{U}=λ_{V}=λ_{Y}.

Using the location network matrix, the recommendation result (or the predicted user-item rating matrix) is also similar to the predicted user-item rating matrix as shown in Table 4. Actually, for all recommendation models in this disclosure, the recommendation results are similar to the predicted user-item rating matrix as shown in Table 4.

With continued reference to the method described in FIG. 4, in block 409, the interesting items with the highest rating values which are generated by merging the user's social information and/or location information are recommended to the users.

Afterwards, the method returns to block 402 where the user's further feedback will be waited to be entered or the old user could update or modify his/her information or a new user enters his/her information. The information here also could include the user's social information and/or location information.

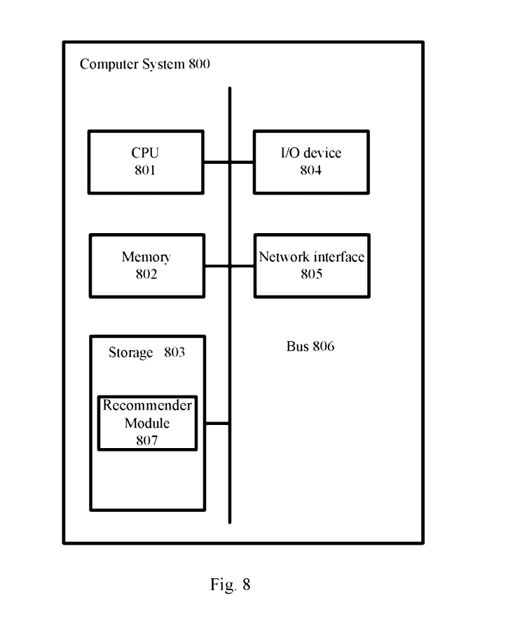

FIG. 8 is a diagram of a computer system 800 implementing examples of the disclosure. Examples of the disclosure may be implemented on virtually any type of computer regardless of the platform being used. For example, as shown in FIG. 8, the computer system 800 includes one or more processor (s) CPU 801, an associated memory 802 (e.g., random access memory (RAM), cache memory, flash memory, etc.), a storage device 803 (e.g., a hard disk, an optical drive such as a compact disk drive or digital video disk (DVD) drive, a flash memory stick, etc.), I/O devices 804 such as a keyboard, a mouse, a microphone (not shown) or a monitor and a network interface 805, which couple with each other with a bus 806.

The memory 802 includes, among others, a recommender module 807 storing machine readable instructions which, when executed by the processor 801, cause the processor to perform the following operations. The memory 802 may include non-transitory machine-readable storage media or any other type of memory. In an example, the operations include performing the method as explained with respect to FIG. 2. In another example, the operations include performing the method as explained with respect to FIG. 4. In yet another example, the recommender system as shown in FIG. 1 may be implemented as the recommender module 807. Another example of the recommender module 807 includes instructions that cause one or more processor(s) 801 to realize the recommender system 100 in FIG. 1 and the methods illustrated in FIG. 2 and FIG. 4. Another example of the recommender module 807 could be implemented as the recommendation engine 102 of the recommender system 100 in FIG. 1 and in this case, at lease one of the user data module 101, the repository 103 and item module 104 depicted in FIG. 1 can be implemented as part of the recommender module 807.

While the disclosure has been described with respect to a limited number of examples, those skilled in the art, having benefit of this disclosure, will appreciate that other example embodiments can be devised which do not depart from the scope of the disclosure as disclosed herein. Accordingly, the scope of the disclosure should be limited only by the attached claims.

What is claimed:

1. A method of recommending at least one item to a user, the method comprising:
receiving the user's feedback on an item;
predicting a user vector and an item vector related to the user in an online mode based on the received feedback; and
recommending to the user an acceptable item based on the predicted user vector and item vector.

2. The method according to claim 1, further comprising:
determining whether the user has any social information;
merging the social information with a user-item matrix to predict the user vector and the item vector.

3. The method according to claim 2, wherein the social information is expressed as a social network matrix.

4. The method according to claim 2, further comprising:
determining whether the user has any location information;
merging the location information with the user-item matrix to predict the user and item vectors.

5. The method according to claim 4, wherein the location information is expressed as a location network matrix.

6. The method according to claim 1, wherein the step of recommending the user the acceptable item is further based on the user's preference.

7. A recommender system, comprising:
at least one processor and a recommendation engine to:
generate a user matrix based on received user's information;
generate an item matrix based on information of one or more items;
predict a rating value of at least one item in an online mode based on a user vector in the user matrix and an item vector in the item matrix; and
recommend to a user an acceptable item based on the ranking of the predicted rating value.

8. The recommender system according to claim 7, where the recommender system further includes at least one element of a group comprised of:
a user data module to store at least one of the user's information and the user's feedback;
an item module to store information of all items to be recommended; and
a repository to store at least one of the user matrix, item matrix and a user-item matrix.

9. The online recommender system according to claim 7, wherein the user's information further includes at least one of social information and location information for use by the recommendation engine to recommend the acceptable item.

10. Apparatus comprising:
a processor; and
a memory storing computer readable instructions executable by the processor to:
update an initial user-item matrix by using an online prediction algorithm; and
recommend to a user an acceptable item based on ratings of items in the updated user-item matrix.

11. The apparatus according to claim 10, wherein the memory further stores instructions which, when executed by the processor, cause the processor to:
generate the initial user-item rating matrix based on a user's information.

12. The apparatus according to claim 10, wherein the memory further stores instructions which, when executed by the processor, cause the processor to:
generate the initial user-item rating matrix based on user's historical data.

13. The apparatus according to claim 10, wherein the online predication algorithm includes a local objective function for an online mode.

14. The apparatus according to claim 13, wherein the local objective function is to be minimized.

15. The apparatus according to claim 13, wherein the local objective function is a root mean square function.
